(19) United States
(12) Patent Application Publication
(10) Pub. No.: US 2010/0127522 A1
(43) Pub. Date: May 27, 2010

(54) Gripping assembly, especially scissor-type clamp, including control mechanism

(76) Inventor: Martin Probst, Erdmannshausen (DE)

Correspondence Address: ECKERT SEAMANS CHERIN & MELLOTT, LLC, U.S. STEEL TOWER, 600 GRANT STREET, PITTSBURGH, PA, 15219-2788, US

(21) Appl. No.: 12/313,929

(22) Filed: Nov. 26, 2008

(51) Int. Cl. B66C 1/10

(52) U.S. Cl. 294/104

(57) ABSTRACT

A gripping assembly, comprising gripper elements (2, 3) adapted to be opened and closed for gripping and clamping a load, is adapted to be secured to the boom of traveling equipment. A control mechanism (40) is provided for controlling the opening and closing movements of gripper elements (2, 3) between an opened and a closed condition. The control mechanism (40) senses the relative movements between two parts of the gripping assembly, with a locking element of the control mechanism (40) being movable between a released position in which gripper elements (2, 3) perform a closing movement and a locked position in which the gripper elements (2, 3) are held in their opened position. When the opened gripping assembly is suspended from the boom and undergoes swinging movements, means, incorporated in control mechanism (40) and adapted to slow down movements of the locking element, prevent the locking element from reaching the released position.

### BACKGROUND OF THE INVENTION

The present invention relates to a gripping assembly, especially a scissor-type clamp, having gripper members for gripping and clamping a load, which incorporates a control mechanism for controlling the opening and closing movements of the gripper elements.

The German Patent No. DE 27 27 919 discloses a control mechanism for a scissor-type clamp, the mechanism comprising a control plate having therein a control groove engaging a control stud secured to the bottom end of a control rod. When the scissor-type clamp is raised with its grippers opened after a load—such as stack of a building material—has been laid down, the control stud engages a recess in an entrainment member. One problem of scissor-type clamps of this type equipped with a control mechanism is that, when the clamp attached to a long boom of a lift vehicle is improperly handled in the condition described, serious difficulties may arise. For example, if the lift vehicle travels over uneven ground on a relatively large building site and under substantial time pressure in order to pick up a load, with the aforesaid control stud engaging the recess in the entrainment member, the boom and thus the clamp itself may swing up and down, the amplitude of such swinging being the greater the longer the boom. As a consequence, a forced upward movement may result in the clamp being accelerated upwards with a very high force so that, as the swinging movement reverses to downwards to lower the boom, the clamp may “hover” for a short period of time, resulting in the aforesaid control stud being removed from the recess in the entrainment member. As gravity starts to act again, the unlocked gripper portion of the clamp drops and continues to do so until the grippers of the clamp meet or until a catch mechanism—comprising chains, for example—limits the closing movement to some predetermined extent. As a consequence of these dynamics, and especially if the drop of the clamp is to be limited, the load surges give rise to enormous forces acting upon the limiting element. As the dynamics are ill-defined, the magnitude of these forces cannot be computed; in the long term, they cause substantial damage to the steel structures of the scissor-type clamp.

In order to avoid such damage, attempts have been made to equip the aforesaid limiting elements with some kind of a damping or spring-action mechanism which avoids impact-like stopping movements and instead slows the drop down over some distance, thereby “softening” it. Surge-limiting damper elements of this kind are very expensive, however; different kinds of scissor clamps require different designs, different hinges and articulations, different dimensions and, particularly, different maintenance schemes.

In the aforesaid scissor clamps, one solution of the problem was obtained by designing the recess for the control stud to be very deep, whereby the swinging movements of the boom would require the control stud to oscillate with a greater amplitude to be undesirably released from the recess. In turn, this would require the over-all design height of the clamp to be increased, so that its use would be limited. A similar scissor-type clamp is disclosed in the German Patent Application No. 91 03 520.1 also.

### SUMMARY OF THE INVENTION

It is therefore a principal object of the present invention to provide a gripping assembly that is simplified in construction and designed to prevent the high-amplitude swinging of the clamp attached to a boom of a lift vehicle from inadvertently unlocking the gripping assembly and causing it to drop.

This object, as well as other objects which will become apparent from the discussion that follows, are achieved, according to the present invention, in the environment of a gripping assembly, having a control mechanism for controlling the opening and closing movements of gripper elements between an opened and a closed condition, by providing a control mechanism which senses the relative movements between two parts of the gripping assembly, with a locking element of the control mechanism being movable between a released position in which gripper elements perform a closing movement and a locked position in which the gripper elements are held in their opened position. When the opened gripping assembly is suspended from the boom and undergoes swinging movements, means, incorporated in control mechanism and adapted to slow down movements of the locking element, prevent the locking element from reaching the released position.

The essential advantage of the gripping assembly, and particularly of the scissor-type clamp according to the invention, is that, when the opened scissor-type clamp, suspended from a long boom, is moved and the boom swings, an undesirable dropping of the clamp's gripper area is safely avoided by the unlocking movement—which occurs as a locking pawl of the control mechanism is released—being slowed down by the specialized damping device.

For this reason, and advantageously, damage to the steel structure of the scissor-type clamp can be reliably avoided, as can injury to operating personnel.

Another essential advantage of the present invention resides in the relatively simple design of the damping device used to slow down the locking pawl. Advantageously, and regardless of the type of the mechanical gripping means, a damping device of this kind is suitable for incorporation in the control mechanism in the same manner throughout. For different weights and configurations of gripping assemblies, it is possible to use a damping device of variously higher or lower strengths.

The present invention thus relates to a gripping assembly, and especially to a scissor-type clamp having a pair of opposing gripper arms and a control mechanism. The clamp is adapted to be secured by fastening means to the boom of a mobile working device, with the control mechanism controlling the opening and the closing of the gripper arms. The control mechanism comprises an entrainment member or locking pawl arranged to be blocked or released by an abutment device in dependence on the scissor clamp movements. In accordance with the invention, means are provided to slow down the movement of the locking pawl from the area of the abutment device in a manner such that undesirable premature release of the locking pawl is avoided when and if the scissor clamp is handled improperly.

Preferably the locking pawls are located in a gripper-side area of the scissor clamp and the abutment device is located in a suspension-side area of the scissor clamp.

In a further development of the invention, the locking pawl and a positioning pawl are provided in a housing portion for movement between a first position, in which they extend from the housing portion, and a second position in which they are retracted into the housing portion. The pawls are moved to cause the following operation to proceed as the scissor clamp is actuated:

(a) As the scissor clamp is lifted, the abutment device reaches under the locking pawl protruding from the housing portion, with the gripper arms being open.

(b) As the scissor clamp is subsequently placed on a load to be clamped, such as a stack of building material, the abutment device releases the locking pawl so that it moves from the area of the abutment device and returns into the housing portion.

(c) The subsequent lifting of the building material stack and the clamping thereof by its own weight between the grippers and by the intrinsic weight of the scissor clamp cause a positioning pawl to be actuated and the locking pawl to by moved from the housing portion.

(d) After the scissor clamp is transported to a prescribed location, and as it is set down and the gripper arms are opened so as to release the load, the abutment device is moved past the locking pawl, with the locking pawl being moved into the housing portion and then re-emerging therefrom.

(e) As the scissor clamp is then lifted, the abutment device reaches under the locking pawl. Initially, the locking pawl moves a short distance upwardly, causing the positioning pawl to be unlocked and to tilt forwardly from the housing portion. In the process, the locking pawl is blocked so that the opened scissor clamp can be lifted. Thus the condition described in (a) is restored.

In another embodiment of the present scissor-type clamp, the positioning pawl actuating the locking pawl is mounted to pivot in the housing portion, with the abutment device having two abutment members placed one above the other, with one of them actuating the positioning pawl above the locking pawl and the other actuating the locking pawl. This embodiment is particularly advantageous when used in a short-stroke gripping assembly.

The damping device preferably comprises a rotation damper including an arm member rotatable about an axis, the arm member having therein a slot engaging an axle connected with the locking pawl so that pivoting movements of the locking pawl are transmitted to the rotation damper and slowed down in the direction of the locking pawl away from the abutment means. The pivoting movement is not slowed down in the opposite direction.

In a particularly preferred embodiment, the rotation damper comprises a conventional hydraulic damper and especially an oil damper. In addition to the aforesaid scissor-type clamp, bell crank lever clamps, single-lever clamps or the like are contemplated for use with gripping assemblies.

For a full understanding of the present invention, reference should now be made to the following detailed description of the preferred embodiments of the invention as illustrated in the accompanying drawings.

### BRIEF DESCRIPTION OF THE DRAWINGS

FIG. 1 shows a scissor-type clamp with an inventive control mechanism in the open condition.

FIG. 2 shows a side view of the scissor-type clamp of FIG. 1 in a partly open condition.

FIG. 3 shows a three-dimensional detailed representation of a control mechanism to be used in accordance with the invention.

FIG. 4 shows a side view of the present control mechanism of FIG. 3, with the scissor-type clamp in a raised position, the clamp's grippers opened.

FIG. 5 shows the control mechanism in a condition in which the scissor-type clamp is placed on top of a load to be clamped, with the grippers opened.

FIG. 6 shows the condition in which the scissor-type clamp is lifted by the boom of a lifting vehicle being swung upwards, with the clamp grippers clamped shut.

FIG. 7 shows the control mechanism in the condition in which the scissor-type clamp and the load therein are set down and the grippers opened.

FIG. 8 is a detailed side view of a curbstone clamping device according to a further preferred embodiment of the invention.

FIG. 9 is a perspective view of the scissor-type clamp according to still another preferred embodiment of the invention.

FIGS. 10a and 10b are representational diagrams illustrating the operation of the scissor-type clamp according to the invention.

### DESCRIPTION OF THE PREFERRED EMBODIMENTS

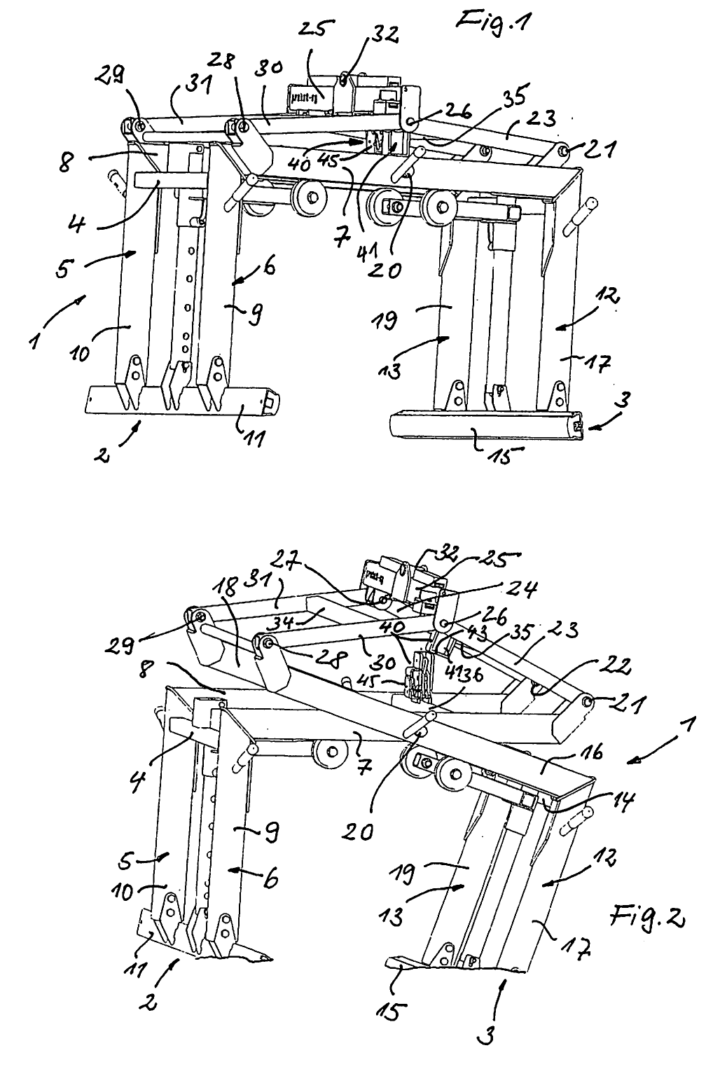

The preferred embodiments of the present invention will now be described with reference to FIGS. 1-10 of the drawings. Identical elements in the various figures are designated with the same reference numerals.

FIG. 1 schematically shows a scissor-type clamp 1 of the type known in the art, which consists essentially of a first gripper element 2 and a second gripper element 3. First gripper element 2 comprises pair of transversely spaced gripper arms 5, 6 interconnected by a first cross member 4. Essentially, gripper arms 5, 6 each have a first portion 7 or 8, respectively, and a second portion 9 and 10, respectively, which preferably are disposed at a substantially right angle. At the bottom free end of portions 9, 10 is disposed a gripper jaw or bar 11 extending in the transverse direction to interconnect portions 9, 10.

Gripper element 3 is constructed correspondingly to comprise transversely spaced gripper arms 12, 13, cross member 14 and gripper bar 15. Gripper arm 12 preferably comprises portions 16, 17 extending at a substantially right angle and gripper arm 13 comprises portions 18, 19 also extending at a substantially right angle, with gripper bar 15 extending in a transverse direction between the lower ends of portions 17, 19. Portions 7, 8 of gripper arms 5, 6 and portions 16, 18 of gripper arms 12, 13 are interconnected for pivoting movement about a transverse axis 20, said axis 20 located about midway between portions 7, 8, 16 and 18 and allowing gripper arms 5, 6 to be pivoted against each other.

At the free ends of portions 7, 8, connector rods 23, 24 are provided to pivot about pivots 21, 22; these rods have their free ends connected with a cross-member 25 to rotate about pivots 26, 27. Correspondingly, the free ends of portions 16, 18 of gripper arms 12, 13 are connected to pivot about pivots 28, 29 with connector rods 30, 31; these rods have their ends connected to cross-member 25 to pivot about pivots 26, 27. Cross-member 25 has centrally connected thereto mounting means 32 allowing scissor clamp 1 to be fastened to a lifting or traveling vehicle (not shown in detail). Gripper arms 5, 6 and 12, 3 are caused to be moved to the closed position by the intrinsic load of scissor clamp 1 suspended from the boom.

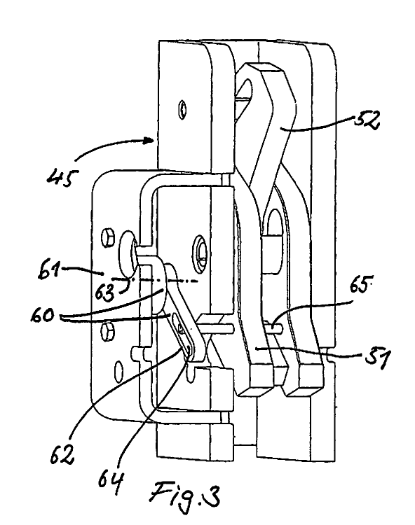

FIGS. 1 and 2 show the scissor clamp in the totally, and in the partly, opened conditions, respectively.

Connector rods 30, 31 are connected about midway by a cross-member 34 while connector rods 23, 24 are connected about midway by a cross-member 35. Further, portions 7 and 8 are interconnected by a cross-member 36; portions 16, 18 are also interconnected by a cross-member (not shown).

Between cross-member 36, which interconnects gripper arm 5, 6, and cross-member 35, which interconnects connector rods 23, 24, there is located a control mechanism 40 referred to schematically as 40 in the FIG. 1 and explained in greater detail in connection with FIG. 3. It is pointed out, however, that control mechanism 40 can be located differently between places which move relatively to each other as gripper arms 5, 6 open and close.

Essentially, and in the manner already explained at the outset, control mechanism 40 comprises an abutment device 41 disposed on cross-member 34 of the scissor clamp 1 and having a bottom abutment member 43. Preferably, the abutment device 41 is U-shaped, with abutment member 43 forming the bottom transverse bar of the U-shape and the legs of the U-shape being secured on or welded to cross-member 35.

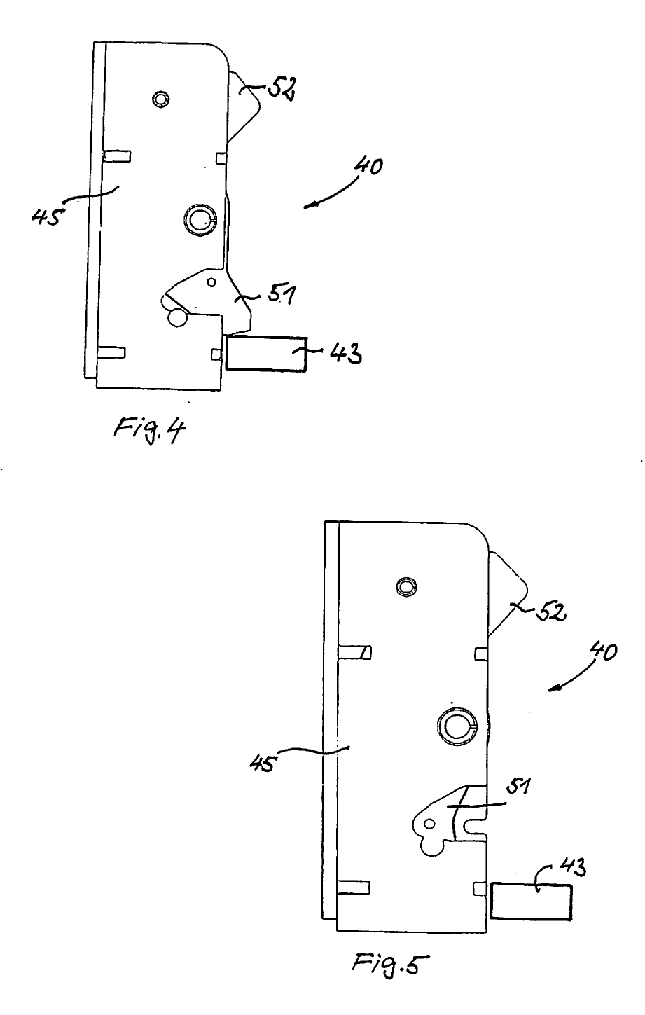

A cross-member 36 has a housing portion 45 fastened—preferably welded—thereto having a side along which abutment member 43 slides when scissor clamp 1 reaches the area of its opened position. In the manner initially explained, the housing portion 45 has mounted thereon a positioning pawl 52 and locking pawl 51, of which the functions are explained in greater detail below under reference to the schematic representations in FIGS. 4 to 8. Details in FIGS. 4 to 8 which were explained under reference to FIG. 3 are referenced correspondingly.

FIG. 4 shows the condition in which scissor clamp 1 is lifted by the boom and gripper arms 9, 10 and 17, 19 are open (FIG. 1). In the manner shown, the locking pawl 51 protrudes from housing 45 to lock abutment device 41 in place, causing a lock to act between cross-member 36 of gripper arms 5, 6 and cross-member 35 between connector rods 23, 24.

As scissor clamp 1 is placed down onto a load to be clamped, with gripper arms 9, 10 and 17, 19 opened, abutment device 41 moves downwards, causing locking pawl 51 to be released and retracted into housing 45.

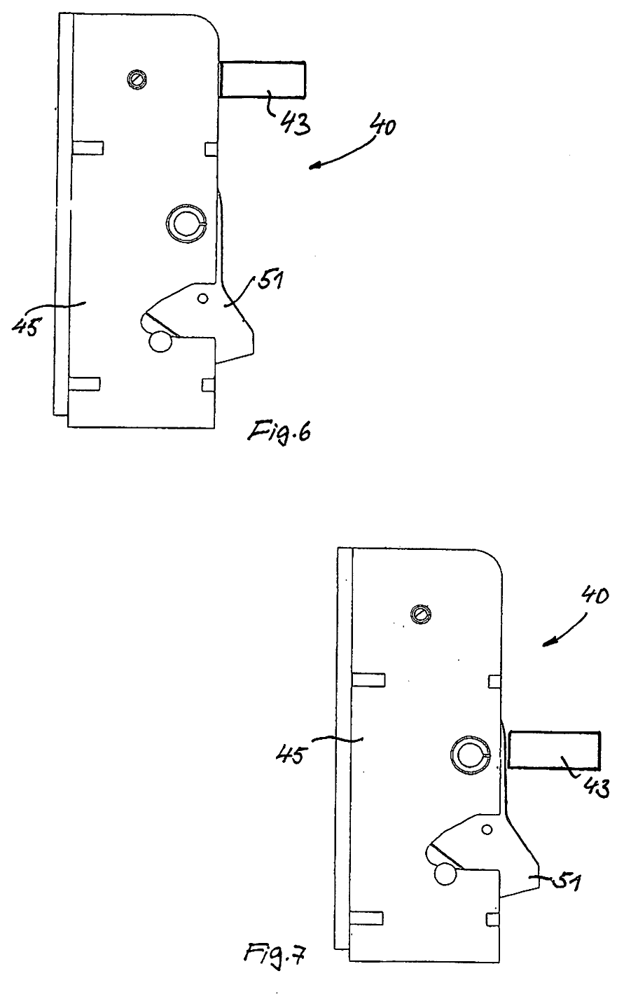

As the boom and scissor clamp 1 are lifted, the abutment device 41 moves upwardly (see FIG. 6) and actuates position pawl 52 so that the latter actuates locking pawl 51 to re-emerge from the housing portion 45. In the process, abutment member 43 moves the positioning pawl 52 into the housing portion 45. At that point, the load has been securely clamped and can be transported to its destination.

To release the load, and as shown in FIG. 7, scissor clamp 1 and the load clamped therein are then placed down on some ground, causing abutment element 43 to move downwardly and to urge locking pawl 51 back into housing 45. After abutment 43 has moved downwardly past locking pawl 51, the latter pivots from the housing 54. During the subsequent lift, abutment member 43 contacts locking pawl 51 from below and moves it slightly upwards, whereby the positioning pawl 52 re-emerges forwardly from housing portion 45. The condition shown in FIG. 4 has again been attained. In this condition, gripper arms 9, 10 and 12, 13 of scissor clamp 1 are open. If scissor clamp 1 is lifted again, the cycle starts anew.

The core of the present invention resides in that, preferably and for the reasons initially detailed, the pivoting-in movement or the return speed of locking pawl 51 from the area of abutment member 43 is damped or slowed down or delayed by a rotation damper 60 (FIG. 3) so that powerful upward and downward swinging boom and clamp movements; e.g., because of rapid travel of the lifting vehicle over uneven ground—cannot result in the clamping area of scissor clamp 1 dropping rapidly because locking pawl 51 inadvertently contacts abutment member 43. In other words, if an upward swing of the boom reverses rapidly to a downward movement of locking pawl 51, which is not loaded from below by member 43 of the abutment device 41 any longer, the rotation damper 60 returns the locking pawl 51 into housing portion in a damped or slowed down manner, preventing the grip range of scissor clamp 1 from being unlocked already and falling downwards as gravity starts to act again. Thus, the rotation damper 60 acts to damp or slow down the return movement of locking pawl 51 into housing portion 45, and it does so in a manner ensuring in any event that, as gravity re-commences to act, locking pawl 51 has not yet left the area of the abutment member 43 and a reliable lock continues to act between cross-member 35 of connector rods 23, 24 and cross-member 36 of gripper arms 5, 6. As the load is lifted thereafter, the abutment member 43 contacts locking pawl 51 from below. Locking pawl 51 moves slightly upwards, causing positioning pawl 52 to re-emerge forwardly from housing portion 45. The condition shown in FIG. 4 has again been attained now.

In accordance with FIG. 3, rotation damper 60, which is fastened to a side wall 61 of housing 45, comprises an arm portion 62 mounted to pivot about an axis 63 of rotation damper 60, such pivoting being slowed down or inhibited by rotation damper 60 as locking pawl 51 returns into housing portion 45. Arm portion 62 has therein a slot 64 engaging an axle 65 connected to the locking pawl 51. As a result, the locking pawl 51 can move into the housing portion 45 only against the damping force that the arm portion 62 of rotation damper 60 exerts, with the aforesaid movement being slowed down to the extent required.

The rotation damper 60 preferably comprises a commercial damper acting to damp pivotings in one direction of rotation (return of the locking pawl into the housing) and allowing a comparably undamped or not slowed movement in the opposite direction (pivoting of the locking pawl outwards from the housing).

Stated in general terms, it is possible also to use other devices such as brakes, gas pressure dampers or the like which are suited to prevent the locking pawl 51 from pivoting out of the area of abutment member 43 under the conditions described above.

FIG. 8 shows an exemplary curbstone laying clamp 40 suited for use in connection with the present invention. Clamp 40 comprises two gripper elements 48, 44 adapted to be pivoted against each other about a pivot 42, with one gripper element 44 adapted to be affixed to a boom of a lifting or transport vehicle (not shown in detail) by a chain link 43. A control mechanism, not shown in detail, may be disposed between gripper elements 48, 44. In FIG. 8, solid lines are used to show the curbstone laying clamp 40 in the closed position, while clamp 40 is shown in the open condition in phantom.

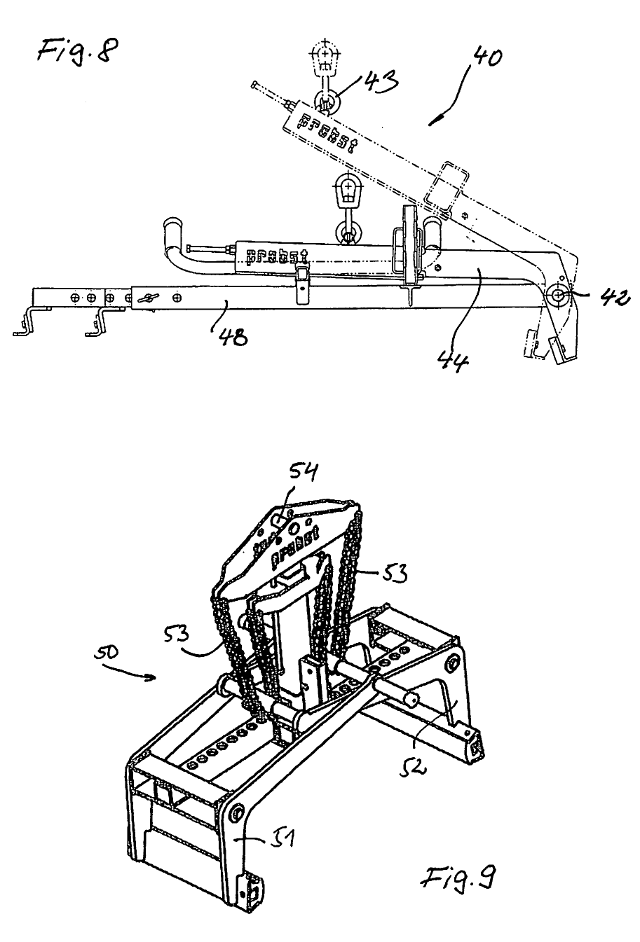

FIG. 9 shows a finished-parts clamp 50 having gripper elements 51 and 52. Clamp 50 may be affixed by means 54 to the boom of a lifting or transport vehicle. Gripper elements 51, 52 are adapted to be opened and closed in a manner known per se by the chain mechanism 53 shown. In this finished-parts clamp too, a control mechanism may be used for sensing the relative movement of gripper elements 51, 52 and for controlling the opening and closing movements thereof.

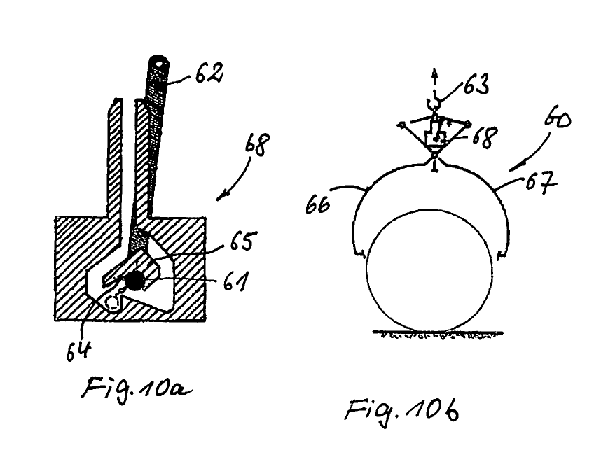

Contemplated also is the use of the present invention in connection with the transport clamps 60 shown in FIGS. 10a, 10b, as disclosed in the above-mentioned German Patent No. DE 27 27 919, for example, having means to prevent, under the conditions explained above that, in the case of upward and downward swings of transport clamp 60 secured to attaching means 63, the control stud 61 on the shift rod 62 leaves the area of control recess 64 on entrainment member 65. In the process, the aforesaid means slows down the movement of control stud 61 from the area of control recess 64. In FIG. 10b, the gripper elements of transport clamp 60 and the control mechanism are referred to as 66, 67 and 68, respectively.

There has thus been shown and described a novel gripping assembly, especially a scissor-type clamp, having a control mechanism, which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A gripping assembly comprising gripper elements adapted to be opened and closed for gripping and clamping a load, said gripping assembly being adapted to be secured to a boom of traveling equipment by a securing device and having a control mechanism for controlling the opening and closing movements of the gripper elements between an open condition and a closed condition, the improvement wherein the control mechanism detects the relative movements of two parts of said gripping assembly, with a locking element of a control mechanism being movable between a released position in which the gripping elements perform a closing movement and a locked position in which the gripping elements are held in their opened position, and wherein swinging movements of the opened gripping assembly suspended from the boom are preventable by means, incorporated in control mechanism, for slowing the movements of said locking element so as to prevent said locking element from reaching its released position.

2. Gripping assembly as in claim 1, wherein the control mechanism includes a locking pawl located on a housing portion and adapted to be moved into the area of an abutment element as said gripping assembly is being lifted so as to keep the gripper elements in the opened condition, such that, as said gripping assembly undergoes swinging movements at the boom, said means for slowing the movements of the locking element from the area of the abutment element preventing the locking pawl from leaving the area of said abutment means.

3. Gripping assembly as in claim 1, wherein the assembly is in the form of a scissor-type clamp upon which the gripper elements are mounted for relative pivoting about a first pivot for opening and closing, with portions of gripper elements which project beyond said first pivot towards the side of securing means are connected in second pivots with connector rods of which the ends opposite said second pivots are pivotable about a third pivot relative to each other and relative to the securing means.

4. Gripping assembly as in claim 2, wherein the control mechanism is disposed in a manner such that the abutment element reaches under the locking pawl in the opened position of the gripper elements, and wherein the abutment element is disposed at a first place of said gripping assembly and a housing portion receiving the locking pawl is disposed at a second place of said gripping assembly, said first and second places being movable relative to each other as gripper elements are opened and closed.

5. Gripping assembly as in claim 2, wherein the abutment element is disposed on the side of securing means relative to second pivots and wherein said housing portion receiving positioning pawl is disposed on the side of gripper elements relative to second pivots.

6. Gripping assembly as in claim 2, wherein the control mechanism incorporates in a housing portion said pivotable locking pawl and a pivotable positioning pawl mechanically coupled with the locking pawl in such a manner that
(1) said locking pawl, when acted upon by the abutment element and said gripping assembly is being lifted with its gripper elements in the open condition, actuates positioning pawl to extend from housing portion;
(2) said locking pawl, when said gripping assembly is being lowered upon a load and contacting some bottom surface, moves abutment element towards said surface and from the area of positioning pawl, whereby said positioning pawl pivots back into housing portion, with positioning pawl remaining in the position pivoted from housing portion;
(3) in the subsequent lifting movement of the gripping assembly, said abutment means moves past said positioning pawl previously pivoted into housing portion and actuates the positioning pawl, causing the latter to be pivoted back into housing portion and actuating locking pawl to be pivoted from housing portion, with the abutment member being free to move past positioning pawl and a load being firmly clamped between gripper elements;
(4) in the subsequent lowering of said gripping assembly to deposit the load after it has been transported to some predetermined location and to open gripper elements, said abutment member moving downwardly past positioning pawl in housing portion and pivoting the locking pawl into the housing portion so that said locking pawl pivots from the housing portion when the abutment member has downwardly passed the area of locking pawl; and
(5) as said gripping assembly is subsequently lifted, with gripper elements opened, the abutment means again reaches under the locking pawl pivoted from the housing portion, said locking pawl when urged by the abutment element actuating positioning pawl to pivot from the housing portion.

7. Gripping assembly as in claim 2, wherein the housing portion is coupled to the movement of a portion of a gripper arm extending beyond axis of rotation towards the side of securing means.

8. Gripping assembly as in claim 2, wherein the abutment element is coupled with the movement of a connector rod.

9. Gripping assembly as in claim 2, wherein said means for slowing down the movement of the locking pawl from the area of the abutment element comprises a fluid damping device.

10. Gripping assembly as in claim 9, wherein the means for slowing movement of the locking pawl from the area of abutment element is a rotation damper having an arm member adapted to be rotated about an axis of rotation and acting upon the locking pawl.

11. Gripping assembly as in claim 10, further comprising an arm member of said rotation damper having therethrough a slot engaging an axle connected with locking pawl.

12. Gripping assembly as in claim 10, further comprising an arm member that is damped by said rotation damper as the locking pawl moves from the area of the abutment element so as to slow down the movement of the locking pawl, and is damped comparatively less as the locking pawl moves in the opposite direction so that the locking pawl can pivot substantially undamped back into the area of the abutment element.
